(19) United States
(12) Patent Application Publication
(10) Pub. No.: US 2025/0171347 A1
(43) Pub. Date: May 29, 2025

(54) METHOD AND SYSTEM FOR REDUCING ATTENUATION IN OPTICAL FIBER

(71) Applicant: CORNING INCORPORATED, CORNING, NY (US)

(72) Inventors: Sushmit Sunil Kumar Goyal, Painted Post, NY (US); Stephan Lvovich Logunov, Corning, NY (US); Hazel Benton Matthews, III, Wilmington, NC (US); Matthew Edward McKenzie, Bath, NY (US); Craig Daniel Nie, Ithaca, NY (US); Pushkar Tandon, Painted Post, NY (US); Chunfeng Zhou, Painted Post, NY (US)

(21) Appl. No.: 18/937,352

(22) Filed: Nov. 5, 2024

Related U.S. Application Data
(60) Provisional application No. 63/603,235, filed on Nov. 28, 2023.

(51) Int. Cl. C03B 37/027

(52) U.S. Cl. CPC C03B 37/02718; C03B 37/02763

(57) ABSTRACT

A method of drawing an optical fiber may include directing an optical fiber comprising an alkali dopant through an inlet of a slow cooling device to a first zone within the slow cooling device and cooling the optical fiber in the first zone, wherein a first residence time t₁ of the optical fiber in the first zone may be greater than or equal to 0.03 sec. The method may further include directing the optical fiber from the first zone to a second zone within the slow cooling device and cooling the optical fiber in the second zone, wherein a second residence time t₂ in the second zone may be greater than the first residence time t₁. A Rayleigh scattering coefficient of the optical fiber drawn may be less than 0.75 dB/km*micron⁴, and an attenuation of the optical fiber drawn may be less than 0.16 dB/km at 1550 nm.

### CROSS-REFERENCE TO RELATED APPLICATIONS

This application claims the benefit of priority under 35 U.S.C. § 119 of U.S. Provisional Application Ser. No. 63/603,235 filed on Nov. 28, 2023, the content of which is relied upon and incorporated herein by reference in its entirety.

### FIELD

This description pertains to optical fibers, more particularly, pertains to alkali doped optical fibers having low attenuation and to methods and systems for reducing attenuation in alkali doped optical fibers.

### BACKGROUND

Alkali doped optical fibers are attractive for their low loss characteristics and have been extensively used in long-haul transmission systems, such as submarine applications. Attenuation in alkali doped optical fibers have multiple contributors, including Rayleigh scattering, small angle scattering, defects, metal impurities and other absorbing species, etc. There is a need to further reduce attenuation in alkali doped optical fibers for enhanced system performance.

### SUMMARY

Described herein includes methods and systems for reducing attenuation in optical fibers. Specifically, by utilizing a non-isothermal slow cooling device configured to provide non-isothermal slow cooling conditions, reduced attenuation in optical fibers, such as alkali doped optical fibers, can be achieved when compared to optical fibers drawn using systems having an isothermal slow cooling device. For example, the inventors have discovered that by configuring at least one upstream controlled cooling zone within the slow cooling device at a higher ambient temperature, which may be targeted towards promoting defect healing to reduce B term contribution to attenuation, and at least one downstream controlled cooling zone within the slow cooling device at a lower ambient temperature, which may be targeted towards facilitating glass relaxation to reduce Rayleigh scattering contribution to attenuation, an overall attenuation reduction may be achieved.

In some embodiments, a method of drawing an optical fiber may include directing an optical fiber comprising an alkali dopant through an inlet of a slow cooling device to a first zone within the slow cooling device and cooling the optical fiber from a first fiber temperature to a second fiber temperature at a first cooling rate in the first zone, wherein: the first zone may have a first average ambient temperature T₁, the first cooling rate may be less than 5000° C./s, and a first residence time t₁ of the optical fiber in the first zone may be greater than or equal to 0.03 sec. The method may further include directing the optical fiber from the first zone to a second zone within the slow cooling device and cooling the optical fiber from a third fiber temperature to a fourth fiber temperature at a second cooling rate in the second zone, wherein: the second zone may have a second average ambient temperature T₂ of at least 900° C., the first average ambient temperature T₁ may be greater than the second average ambient temperature T₂ by at least 100° C., the third fiber temperature may be less than or equal to the second fiber temperature, the second cooling rate may be greater than the first cooling rate and less than 5000° C./s, and a second residence time t₂ in the second zone may be greater than the first residence time t₁, wherein a ratio of the second residence time t₂ to the first residence time t₁ may be greater than or equal to 1.5:1. A Rayleigh scattering coefficient of the optical fiber drawn may be less than 0.75 dB/km*micron⁴, and an attenuation of the optical fiber drawn may be less than 0.16 dB/km at 1550 nm.

In some embodiments, a method of drawing an optical fiber may include directing an optical fiber comprising an alkali dopant through an inlet of a slow cooling device to a first zone within the slow cooling device and cooling the optical fiber from a first fiber temperature to a second fiber temperature at a first cooling rate in the first zone, wherein: the first zone may have a first average ambient temperature T₁, and the first cooling rate may be less than 5000° C./s. The method may further include directing the optical fiber from the first zone to a second zone within the slow cooling device and cooling the optical fiber from a third fiber temperature to a fourth fiber temperature at a second cooling rate in the second zone, wherein: the second zone may have a second average ambient temperature T₂ of at least 900° C., the first average ambient temperature T₁ may be greater than the second average ambient temperature T₂ by at least 100° C., the third fiber temperature may be less than or equal to the second fiber temperature, the second cooling rate may be greater than the first cooling rate and less than 5000° C./s, and a ratio of a first residence time t₁ of the optical fiber in the first zone to a second residence time t₂ in the second zone may be greater than or equal to 0.14 and less than or equal to 5.3. A Rayleigh scattering coefficient of the optical fiber drawn may be less than 0.75 dB/km*micron⁴, and an attenuation of the optical fiber may be less than 0.16 dB/km at 1550 nm.

In some embodiments, a method of drawing an optical fiber may include directing an optical fiber comprising an alkali dopant through an inlet of a slow cooling device to a first zone within the slow cooling device and cooling the optical fiber from a first fiber temperature to a second fiber temperature at a first cooling rate in the first zone, wherein: the first zone may have a first average ambient temperature T₁ that may be greater than or equal to 1070° C. and less than or equal to 1320° C., and a first residence time t₁ of the optical fiber in the first zone is greater than or equal to 0.03 sec and less than or equal to 1 sec. The method may further include directing the optical fiber from the first zone to a second zone within the slow cooling device and cooling the optical fiber from a third fiber temperature to a fourth fiber temperature at a second cooling rate in the second zone, wherein: the third fiber temperature may be less than or equal to the second fiber temperature, the second cooling rate may be greater than the first cooling rate and less than 5000° C./s, the second zone may have a second average ambient temperature T₂ that may be greater than or equal to 900° C. and less than or equal to 1200° C., and a second residence time t₂ in the second zone may be greater than or equal to 0.03 sec and less than or equal to 2 sec. A Rayleigh scattering coefficient of the optical fiber drawn may be less than 0.75 dB/km*micron⁴, and an attenuation of the optical fiber drawn may be less than 0.16 dB/km at 1550 nm.

Additional features and advantages will be set forth in the detailed description which follows, and in part will be readily apparent to those skilled in the art from the description or recognized by practicing the embodiments as described in the written description and claims hereof, as well as the appended drawings.

### BRIEF DESCRIPTION OF THE DRAWINGS

The accompanying drawings are included to provide a further understanding and are incorporated in and constitute a part of this specification. The drawings illustrate one or more embodiment(s), and together with the detailed description serve to explain principles and operation of the various embodiments. As such, the disclosure will become more fully understood from the following detailed description, taken in conjunction with the accompanying figures.

FIG. 1 schematically illustrates a system for drawing optical fibers according to some embodiments.

FIG. 2 shows attenuation of alkali doped optical fibers as a function of temperature of an isothermal slow cooling device configured to provide a constant ambient temperature.

FIG. 3 shows respective contributions of Rayleigh scattering and B term to the total attenuation of FIG. 2.

FIG. 4 shows attenuation of alkali doped optical fibers drawn at different slow cooling conditions, with some at isothermal slow cooling conditions and others at non-isothermal slow cooling conditions.

FIG. 5 shows B term contribution to the total attenuation of FIG. 4.

FIG. 6 shows an exemplary relative refractive index profile of an alkali doped fiber.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

In this specification and in the claims which follow, reference will be made to a number of terms which shall be defined to have the following meanings:

Fiber temperature refers to the average temperature of the core and cladding regions of a glass optical fiber.

Fictive temperature refers to the average fictive temperature of the core and cladding regions of a glass optical fiber.

Ambient refers to an environment to which an optical fiber is exposed during processing.

Ambient temperature refers to a temperature of the environment to which an optical fiber is exposed during processing.

Reference will now be made in detail to illustrative embodiments of the present description.

In the process of manufacturing an optical fiber, an optical fiber preform is first produced from a soot blank. For example, using a vapor deposition method, the soot blank is formed by depositing layers of silica-containing soot onto a rotating deposition surface. The soot blank is then dried in a consolidation furnace in a drying gas atmosphere. Once dried, the soot blank may be doped to raise or lower the refractive index of one or more portions of the soot blank, as compared to pure silica. Once the soot blank is sufficiently doped, the soot blank is heated to an elevated temperature until the soot blank vitrifies and produces a consolidated glass preform. The preform is then drawn into an optical fiber using a draw furnace.

Alkali doped silica optical fibers have been extensively used for low loss optical fiber applications. Attenuation in alkali doped optical fibers have multiple contributors, including Rayleigh scattering, small angle scattering, defects, metal impurities and absorbing species, etc. To reduce attenuation in alkali doped optical fibers, a heated furnace—typically, an isothermal slow cooling device having a substantially uniform ambient temperature within a controlled cooling region of the slow cooling device—has been used to facilitate relaxation of glass in the glass transition region of the alkali doped optical fiber to lower the fictive temperature and Rayleigh scattering, along with thermal annealing of some absorbing defects that may be formed during the draw process.

The inventors have discovered that by using a non-isothermal slow cooling device with an upper zone within the controlled cooling region having an ambient temperature higher than the ambient temperature of a lower zone within the controlled cooling region, further reduction in attenuation in alkali doped optical fibers can be achieved. Specifically, the lower zone of the slow cooling device may be configured to have an ambient temperature that may be targeted towards more effectively promoting glass relaxation to minimize Rayleigh scattering contribution to the attenuation, while the upper zone of the slow cooling device may be configured to have an ambient temperature greater than the ambient temperature of the lower zone. Surprisingly, an overall reduction in the attenuation at 1550 nm has been achieved with such non-isothermal configurations.

Without intending to be bound by theory, the inventors have found that by increasing the ambient temperature of the upper zone (to a temperature greater than the temperature for minimizing Rayleigh scattering), more effective healing of defects in the alkali doped optical fiber may be achieved as the alkali doped optical fiber may enter into the upper zone at high temperatures, thereby achieving an overall reduction in the attenuation. The inventors have discovered that defect healing and glass relaxation may be balanced to achieve the overall reduction in attenuation by configuring the upper zone of the slow cooling device at a higher ambient temperature to promote defect healing and configuring the lower zone of the slow cooling device at a lower ambient temperature to minimize Rayleigh scattering.

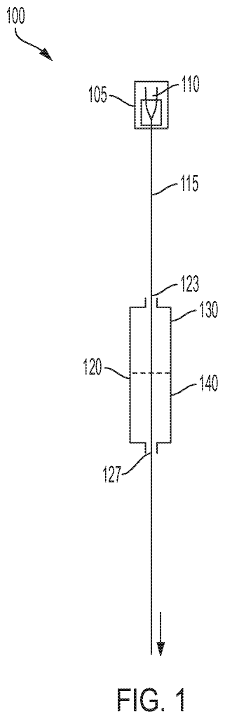

FIG. 1 schematically illustrates a system 100 for drawing optical fibers. The system 100 may include a draw furnace 105 with a fiber preform 110 situated in the draw furnace 105. In some embodiments, the fiber preform 110 may include a doped silica preform having a single compositional region or multiple compositional regions. In some embodiments, the multiple compositional regions may be concentric. For example, in some embodiments, the fiber preform 110 may include a central region having a composition corresponding to the composition of a core region of a fiber and one or more outer concentric regions having compositions corresponding to compositions of one or more cladding layers of the fiber. The core and/or cladding regions may include pure silica or doped silica.

In some embodiments, the fiber may be an alkali doped optical fiber. For example, in some embodiments, the core region may include silica-based glass having an up-dopant. In some embodiments, the core region may include silica-based glass doped with at least one alkali. In some embodiments, the core region may include silica-based glass doped with one or more alkali chosen from a group comprising lithium, sodium, potassium, rubidium or a combination thereof. In some embodiments, the dopant consists of lithium, sodium, potassium, rubidium or a combination thereof. In some embodiments, the dopant consists essentially of lithium, sodium, potassium, rubidium or a combination thereof. When the core region includes two or more alkali dopants, the average concentration of alkali dopant is the sum of the average concentration of each of the individual alkali dopants. In some embodiments, the average concentration of alkali in the core region may be in the range from 10 ppm to 500 ppm, or from 20 ppm to 500 ppm, or from 25 ppm to 400 ppm, or from 50 ppm to 300 ppm. In some embodiments, the silica glass of the core region may be free or substantially free of germanium and/or chlorine.

With continued reference to FIG. 1, the system 100 may include a slow cooling device 120 positioned downstream of the draw furnace 105. An optical fiber 115, for example, an alkali doped optical fiber 115, may be drawn from the fiber preform 110 and directed to an inlet 123 of the slow cooling device 120. The optical fiber 115 may pass through the slow cooling device 120 and may emerge at an outlet 127 of the slow cooling device 120. The temperature of the optical fiber 115 at the outlet 127 may be less than the temperature of the optical fiber 115 at the inlet 123. As will be discussed in more detail below, the slow cooling device 120 may include zones configured at different ambient temperatures for further reducing attenuation in the alkali doped optical fiber 115.

Although not explicitly shown in FIG. 1, the fiber process pathway may further include other processing units positioned upstream or downstream from the slow cooling device 120 (e.g., reheating stages, additional slow cooling devices, metrology units, fiber-turning devices, coating units, testing units, spooling units etc.) along the process pathway.

The system 100 may define a process pathway along which the optical fiber 115 may be directed or conveyed. The process pathway may be the route traversed by the optical fiber 115 in the fiber draw process. The process pathway of the system 100 may extend from the draw furnace 105 to beyond the outlet 127 of the slow cooling device 120. The arrow defines the direction of conveyance of the optical fiber 115 along the process pathway. As the optical fiber 115 is processed, it exits the draw furnace 105 and proceeds along the process pathway. Positions along the process pathway that are closer to the point of exit of the optical fiber 115 from the draw furnace 105 are said herein to be upstream of positions along the process pathway that are further away from the point of exit of the optical fiber 115 from the draw furnace 105, where distance from the draw furnace 105 may be understood herein to mean distance as measured along the optical fiber 115 or the process pathway. The direction of conveyance of the optical fiber 115 may be the downstream direction; the optical fiber 115 may be conveyed from upstream positions to downstream positions along the process pathway. For example, the portion of the optical fiber 115 positioned between the draw furnace 105 and the inlet 123 of the slow cooling device 120 may be upstream of the portion of the optical fiber 115 positioned further from the draw furnace 105 than the outlet 127 of the slow cooling device 120. Similarly, the inlet 123 of the slow cooling device 120 may be upstream of the outlet 127 of the slow cooling device 120 and the draw furnace 105 may be upstream of the slow cooling device 120. Since the optical fiber 115 may pass through both the draw furnace 105 and slow cooling device 120 along the process pathway, the draw furnace 105 and the slow cooling device 120 may be referred to herein as being operatively coupled along the process pathway.

In some embodiments, the draw speed (speed of conveyance) of the optical fiber 115 along the pathway through the slow cooling device 120 may be greater than or equal to 20 m/s, greater than or equal to 25 m/s, greater than or equal to 30 m/s, greater than or equal to 35 m/s, greater than or equal to 40 m/s, greater than or equal to 45 m/s, greater than or equal to 50 m/s, greater than or equal to 55 m/s, greater than or equal to 60 m/s, greater than or equal to 65 m/s, greater than or equal to 70 m/s, or greater. In some embodiments, the draw speed of the optical fiber 115 along the pathway through the slow cooling device 120 may be greater than or equal to 20 m/s and less than or equal to 70 m/s, greater than or equal to 30 m/s and less than or equal to 70 m/s, greater than or equal to 40 m/s and less than or equal to 70 m/s, greater than or equal to 50 m/s and less than or equal to 70 m/s, greater than or equal to 60 m/s and less than or equal to 70 m/s, greater than or equal to 20 m/s and less than or equal to 60 m/s, greater than or equal to 30 m/s and less than or equal to 60 m/s, greater than or equal to 40 m/s and less than or equal to 60 m/s, greater than or equal to 50 m/s and less than or equal to 60 m/s, greater than or equal to 20 m/s and less than or equal to 50 m/s, greater than or equal to 30 m/s and less than or equal to 50 m/s, greater than or equal to 40 m/s and less than or equal to 50 m/s, greater than or equal to 20 m/s and less than or equal to 40 m/s, greater than or equal to 30 m/s and less than or equal to 40 m/s, or greater than or equal to 20 m/s and less than or equal to 30 m/s.

Referring back to FIG. 1, as the optical fiber 115 exits the draw furnace 105, the optical fiber 115 may exit the draw furnace 105 at a fiber temperature of ˜1700° C. in some embodiments. As the optical fiber 115 is conveyed along the process pathway, the optical fiber 115 may proceed to the slow cooling device 120. The slow cooling device 120 may effect controlled cooling of the optical fiber 115 and enable cooling rates slower than the natural cooling rate of the optical fiber 115 in unheated air.

In a conventional design, the controlled cooling region of the slow cooling device is maintained at a constant or isothermal ambient temperature between room temperature and the temperature of the optical fiber at the inlet of the slow cooling device. In contrast, the slow cooling device 120 described herein may include controlled cooling zones within the controlled cooling region that may establish different or non-isothermal ambient temperatures within the slow cooling device 120 to which the optical fiber 115 may be exposed. Each of the controlled cooling zones may be internal to the slow cooling device 120 and may encompass a portion of the internal volume of the slow cooling device 120 thereof. The optical fiber 115 may pass through the controlled cooling zones as it proceeds along the process pathway from the inlet 123 to the outlet 127 of the slow cooling device 120. In some embodiments, the ambient temperatures of the controlled cooling zones may be established with heating elements and/or heated gas flow in the environment near the optical fiber 115.

Referring to FIG. 1, in some embodiments, the slow cooling device 120 may include at least a first controlled cooling zone or first zone 130. In some embodiments, the slow cooling device 120 may further include at least a second controlled cooling zone or second zone 140 downstream from the first zone 130. Thus, the first zone 130 may also be referred to as an upstream zone, and the second zone 140 may be referred to as a downstream zone. The optical fiber 115 may be directed through the inlet 123 of the slow cooling device 120 into the first zone 130. The optical fiber 115 may be cooled from a first fiber temperature (the temperature of the optical fiber 115 entering the first zone 130) to a second fiber temperature (the temperature of the optical fiber 115 exiting the first zone 130) over a first residence time t₁ of the optical fiber 115 in the first zone 130. A first cooling rate within the first zone 130 may be defined as: (first fiber temperature−second fiber temperature)/first residence time t₁. The optical fiber 115 may then be directed from the first zone 130 to the second zone 140 within the slow cooling device 120. The optical fiber 115 may be cooled from a third fiber temperature (the temperature of the optical fiber 115 entering the second zone 140) to a fourth fiber temperature (the temperature of the optical fiber 115 exiting the second zone 140) over a second residence time t₂ of the optical fiber 115 in the second zone 140. A second cooling rate within the second zone 140 may be defined as: (third fiber temperature−fourth fiber temperature)/second residence time t₂. The third fiber temperature may be less than or equal to the second fiber temperature. The first zone 130 may have a first average ambient temperature T₁, and the second zone 140 may have a second average ambient temperature T₂ different from the first average ambient temperature T₁.

In some embodiments, the first zone 130 and the second zone 140 may be adjacent with no intervening zones. In some embodiments, the first zone 130 may be adjacent to the inlet 123 of the slow cooling device 120. In some embodiments, the second zone 140 may be adjacent to the outlet 127 of the slow cooling device 120. In some embodiments, the first zone 130 and the second zone 140 may be separated by one or more intervening zones. In some embodiments, the first zone 130 may be separated from the inlet 123 by one or more intervening zones. In some embodiments, the second zone 140 may be separated from the outlet 127 by one or more intervening zones.

In some embodiments, the first cooling rate within the first zone 130 may be less than 5000° C./s, less than 4000° C./s, less than 3500° C./s, less than 3000° C./s, less than 2500° C./s, or less than 2000° C./s, or less than 1500° C./s, or in the range from 1000° C./s-4500° C./s, in the range from 1500° C./s-4000° C./s, or in the range from 2000° C./s-3500° C./s.

In some embodiments, the second cooling rate within the second zone 140 may be less than 5000° C./s, less than 4000° C./s, less than 3500° C./s, less than 3000° C./s, less than 2500° C./s, or less than 2000° C./s, or less than 1500° C./s, or in the range from 1000° C./s-4500° C./s, in the range from 1500° C./s-4000° C./s, or in the range from 2000° C./s-3500° C./s.

In some embodiments, the first cooling rate within the first zone 130 may be different from the second cooling rate within the second zone 140. For example, in some embodiments, the second cooling rate within the second zone 140 may be greater than the first cooling rate within the first zone 130. In some embodiments, the second cooling rate within the second zone 140 may be greater than the first cooling rate within the first zone 130 by at least 250° C./s, at least 500° C./s, at least 750° C./s, at least 1000° C./s, or by an amount in the range from 250° C./s-2000° C./s, 500° C./s-1750° C./s, or 750° C./s-1500° C./s. In some embodiments, the second cooling rate within the second zone 140 may be greater than the first cooling rate within the first zone 130 by at least 5%, at least 10%, at least 15%, at least 20%, or by an amount in the range from 5%-25%, or in the range from 10%-20%.

In some embodiments, the first zone 130 and the second zone 140 may each have a constant or uniform ambient temperature. The first average ambient temperature T₁ and the second average ambient temperature T₂ then refer to the constant or uniform ambient temperature within the first zone 130 and the second zone 140, respectively. In some embodiments, the ambient temperature within the first zone 130 may vary. In some embodiments, the ambient temperature in the first zone 130 may vary from a maximum ambient temperature to a minimum ambient temperature within the first zone 130. The first average ambient temperature T₁ refers to an average of the maximum ambient temperature and the minimum ambient temperature within the first zone 130. In some embodiments, the ambient temperature within the second zone 140 may vary. In some embodiments, the ambient temperature in the second zone 140 may vary from a maximum ambient temperature to a minimum ambient temperature within the second zone 140. The second average ambient temperature T₂ refers to an average of the maximum ambient temperature and the minimum ambient temperature within the second zone 140. Within the respective first zone 130 or second zone 140, in some embodiments, the difference between the maximum ambient temperature and the minimum ambient temperature may be less than or equal to 30° C., less than or equal to 20° C., less than or equal to 10° C., less than or equal to 1° C., and in some embodiments, the difference between the maximum ambient temperature and the minimum ambient temperature may be greater than or equal to 0° C. and less than or equal to 30° C., greater than or equal to 0° C. and less than or equal to 20° C., greater than or equal to 0° C. and less than or equal to 10° C., greater than or equal to 0° C. and less than or equal to 1° C.

In some embodiments, the first average ambient temperature T₁ may be greater than or equal to 1070° C., greater than or equal to 1100° C., greater than or equal to 1150° C., greater than or equal to 1200° C., greater than or equal to 1250° C. In some embodiments, the first average ambient temperature T₁ may be less than or equal to 1320° C., less than or equal to 1300° C., less than or equal to 1275° C., or less than or equal to 1250° C. In some embodiments, the first average ambient temperature T₁ may be greater than or equal to 1070° C. and less than or equal to 1320° C.—including all sub-ranges or values therebetween. For example, in some embodiments, the first average ambient temperature T₁ may be greater than or equal to 1150° C. and less than or equal to 1250° C., greater than or equal to 1150° C. and less than or equal to 1275° C., greater than equal to 1200° C. and less than or equal to 1275° C., or greater than equal to 1250° C. and less than or equal to 1300° C.

In some embodiments, the second average ambient temperature T₂ may be greater than or equal to 900° C., greater than or equal to 950° C., greater than or equal to 975° C., greater than or equal to 1000° C., greater than or equal to 1025° C., or greater than or equal to 1050° C. In some embodiments, the second average ambient temperature T₂ may be less than or equal to 1200° C., less than or equal to 1150° C., less than or equal to 1100° C., or less than or equal to 1050° C. In some embodiments, the second average ambient temperature T₂ may be greater than or equal to 900° C. and less than or equal to 1200° C.—including all sub-ranges or values therebetween. For example, in some embodiments, the second average ambient temperature T₂ may be greater than or equal to 900° C. and less than equal to 1150° C., greater than or equal to 950° C. and less than or equal to 1100° C., or greater than or equal to 975° C. and less than or equal to 1050° C.

As discussed above, the first average ambient temperature T₁ within the first zone 130 may be different from the second average ambient temperature T₂ within the second zone 140. The first average ambient temperature T₁ may be greater than the second average ambient temperature T₂.

In some embodiments, the first average ambient temperature T₁ may be greater than the second average ambient temperature T₂ by at least 100° C. In some embodiments, a difference between the first average ambient temperature T₁ and the second average ambient temperature T₂ may be greater than or equal to 100° C., greater than or equal to 110° C., greater than or equal to 120° C., greater than or equal to 130° C., greater than or equal to 140° C., or greater than or equal to 145° C. In some embodiments, the difference between the first average ambient temperature T₁ and the second average ambient temperature T₂ may be less than or equal to 200° C., less than or equal to 190° C., less than or equal to 180° C., less than or equal to 170° C., less than or equal to 160° C., less than or equal to 150° C., less than or equal to 140° C. In some embodiments, the difference between the first average ambient temperature T₁ and the second average ambient temperature T₂ may be greater than or equal to 100° C. and less than or equal to 200° C.—including all sub-ranges or values therebetween. For example, in some embodiments, the difference between the first average ambient temperature T₁ and the second average ambient temperature T₂ may be greater than or equal to 105° C. and less than or equal to 180° C., greater than or equal 112° C. and less than or equal to 176° C., greater than or equal to 120° C. and less than or equal to 170° C., greater than or equal to 129° C. and less than or equal to 158° C., or greater than or equal to 142° C. and less than or equal to 155° C.

The inventors have discovered that by using the non-isothermal slow cooling device 120 described herein, a surprisingly lower attenuation in the optical fiber 115, such as alkali doped optical fibers, can be achieved when compared to optical fibers drawn using a system with an isothermal slow cooling device. Without intending to be bound by any particular theory, the second average ambient temperature T₂ of the second zone 140 of the slow cooling device 120 described herein may effectively minimize Rayleigh scattering contribution to the attenuation in alkali doped optical fibers. The inventors have discovered that the first average ambient temperature T₁ of the first zone 130 of the slow cooling device 120, although greater than the temperature optimal for minimizing Rayleigh scattering, may allow for more effective healing of defects in glass composition of alkali doped optical fibers, thereby reducing B term contribution, which includes the attenuation contribution associated with defects in the glass composition, as will be discussed in more detail below. Thus, the non-isothermal configuration of the slow cooling device 120 described herein may balance defect healing for reducing B term contribution to attenuation and glass relaxation for minimizing Rayleigh scattering contribution to attenuation to achieve an overall reduction in attenuation.

The total attenuation of an optical fiber (without any induced bending) consists of scattering loss and absorption (both intrinsic and extrinsic). The scattering loss is a combination of Rayleigh, Raman, and Brillouin scattering as well as Small Angle Scattering (SAS). Extrinsic absorption includes atomic defects in the glass composition, such as atoms that are displaced and are not in the proper place in a crystal lattice structure. Extrinsic absorption also includes impurities in the glass material. Intrinsic absorption is caused by the basic constituent atoms of the fiber material, such as the inherent absorption of the material of the optical fiber itself. Thus, the total attenuation may be represented by Equation (1) below:

$$Total Attenuation = Rayleigh Scattering Loss + SAS + Intrinsic Absorption + Extrinsic Absorption ( defects ) + Entrinsic Absorption ( impurities ) \qquad Eq . ( 1 )$$

It is noted that for purpose of the present disclosure, the Rayleigh Scattering Loss in equation (1) above is a combination of Rayleigh, Raman, and Brillouin scattering losses. However, it is described hereinafter as Rayleigh Scattering Loss since Rayleigh is a dominant contributor to the scattering loss over Raman and Brillouin. It is further noted that in the present disclosure, Intrinsic Absorption, Extrinsic Absorption (defects), and Extrinsic Absorption (impurities) in Equation (1) are collectively referred to as B term contribution to the total attenuation.

The Total Attenuation in Equation (1) is measured using Optical Time Domain Reflectometry (OTDR) method at 1550 nm, as is well known in the art. The Rayleigh Scattering Loss in equation (1) is a combination of Rayleigh, Raman, and Brillouin scattering losses, as discussed above, and is first calculated at the visible wavelength range (400 nm-1000 nm). Based upon this calculation, the Rayleigh Scattering Loss for the infrared wavelength range (1550 nm) is then extrapolated, as discussed further below.

The Rayleigh Scattering Loss a (dB/km) is first calculated at the visible wavelength range (400 nm-1000 nm) using Equation (2) below:

$$α = R / {λ}^{4} \qquad Eq . ( 2 )$$

where R is the Rayleigh scattering coefficient (dB/km*micron⁴), which is measured using the spectral cutback method, as is known in the art, and plotting attenuation vs. the inverse of wavelength to the fourth power over the visible range (400 nm to 1000 nm). The slope of this plot is equal to the Rayleigh scattering coefficient (R). The wavelength k (microns) in Equation 2 is in the visible range (0.4 microns to 1.0 microns, which is equal to 400 nm to 1000 nm).

The Rayleigh scattering coefficient R in Equation (2) is over the visible wavelength range and, therefore, represents the Rayleigh scattering coefficient R of the core of the fiber since the light is essentially confined to the core over the visible wavelength range. However, at 1550 nm, the mode field diameter of the fiber is larger and, as a result, a finite amount of light is also in the cladding. The Rayleigh Scattering Loss a calculated in Equation (2), however, assumes that the light propagates only within the core of the optical fiber and does not take into account the propagation of light within the cladding. Equation (3) below determines the Rayleigh Scattering Loss of an optical fiber while accounting for both the propagation of light within the core and cladding. Therefore, Equation (3) is used to determine the Rayleigh scattering loss at 1550 nm.

$${α}^{′} = \frac{{\int }_{0}^{∞} α ( r ) {( f ( r ) )}^{2} rdr}{{\int }_{0}^{∞} {( f ( r ) )}^{2} rdr} \qquad Eq . ( 3 )$$

where α′ is the Rayleigh Scattering Loss at 1550 nm (dB/km), α(r) is the adjusted Rayleigh Scatting Loss (dB/km), f(r) is the transverse component of the electric field of the guided optical signal, and r is the radial position in the fiber. When r is less than or equal to the core radius of the optical fiber, α(r) is equal to the Rayleigh Scattering Loss a from Equation (2). When r is greater than the core radius of the optical fiber, then α(r) is equal to the Rayleigh scattering loss of the cladding of the optical fiber.

The Rayleigh scattering coefficient of the cladding depends on the composition of the cladding and the temperature-time history of the cladding in the slow cooling device. The temperature-time history impacts the Rayleigh scattering of the cladding by influencing the glass relaxation of the cladding glass in its glass transition region and changing its fictive temperature. In some embodiments, when the cladding is comprised of silica doped fluorine such that the concentration of fluorine is within the range of 0.75 wt. % to 1.2 wt. %, the Rayleigh scattering coefficient of the cladding is about 0.95 μm⁴-dB/km. For a cladding Rayleigh scattering coefficient of 0.95 μm⁴-dB/km, the cladding Rayleigh scattering loss α(r) at 1550 nm (1.550 μm) is equal to (0.95 μm⁴-dB/km)/(1.55 μm)⁴=0.165 dB/km. In some embodiments, the cladding Rayleigh scattering coefficient is between 0.88 dB/km*micron⁴ and 0.98 dB/km*micron⁴. In other embodiments, the cladding Rayleigh scattering coefficient is between 0.9 dB/km*micron⁴ and 0.96 dB/km*micron⁴. However, when r is greater than the core radius, it is also known to use other values of α(r) based upon, for example, the concentration of fluorine in the cladding of the optical fiber. As discussed above, the Rayleigh Scattering Loss at 1550 nm (α′) is the total Rayleigh Scattering Loss and is the combination of Rayleigh, Raman, and Brillouin scattering.

Based on the Rayleigh Scattering Loss at 1550 nm in the core of the optical fiber and the Rayleigh scattering loss at 1550 nm in the cladding of the optical fiber, an average Rayleigh scattering coefficient of the optical fiber may be determined by weighing the Rayleigh scattering coefficient of the core and the Rayleigh scattering coefficient of the cladding by the intensity of the Rayleigh scattering loss in the core and the Rayleigh scattering loss in the cladding, respectively, using Equation (4) below. The weighted average Rayleigh scattering coefficient is referred to as the Rayleigh scattering coefficient of the optical fiber.

$$Rayleigh Scattering coefficient of fiber = {R}_{a v g} = \frac{{\int }_{0}^{{r}_{c o r e}} {{R}_{c o r e} ( f ( r ) )}^{2} rdr + {\int }_{{r}_{core}}^{∞} {{R}_{cladding} ( f ( r ) )}^{2} rdr}{{\int }_{0}^{∞} {( f ( r ) )}^{2} rdr} \qquad Eq . ( 4 )$$

where r_{core} is the core radius of the optical fiber, R_{core} is the Rayleigh scattering coefficient of the core, R_{cladding} is the Rayleigh scattering coefficient of the cladding, f(r) is the transverse component of the electric field of the guided optical signal, and r is the radial position in the fiber.

The SAS in Equation (1) is a fraction of total scattering in the optical fiber and provides microstructural information over a very small angular range of the fiber axis. The SAS is measured by placing the optical fiber to be measured in two separate angular scattering measurement setups.

The first setup measures a wide-angle component and the second setup measures a small angle component.

The wide-angle setup is comprised of a half cylinder made of high purity fused silica (HPFS). The half cylinder is thoroughly polished on all sides to minimize surface roughness. A flat part of the cylinder is painted black except for a small aperture at the center. The optical fiber under study is stripped of its protective polymer coating and is placed within a groove in a black steel plate. The fiber-steel plate assembly is then covered by the HPFS half cylinder. An index matching gel is used to eliminate an air gap, if any, between the half cylinder and the optical fiber.

The angular distribution of scattering is measured by an InGaAs optical detector moving in a semicircular motion in a plane containing the fiber. The wide-angular range measured in this first setup is from 20 degrees to 160 degrees.

An entirely different setup is used for measuring the small-angular range from 0 degrees to 30 degrees. In this setup, the fiber is placed between two HPFS stacked roof prisms, each prism having a first base side angle of 90° and a second base side angle of 135°, the base side angles being measured with respect to a bottom surface of the prisms. The length and the height of the prisms are each 10 cm and 5 cm, respectively. A planoconvex HPFS lens is positioned on top of the upper prism. All air gaps between the two prisms, optical fiber, and the lens are eliminated by the index matching gel. An angled surface of the bottom prism, which is formed by the second base side angle of 135°, is coated with silver so that it is reflective. The light scattered from the fiber is reflected from the angled surface and subsequently refracted by the planoconvex HPFS lens. The InGaAs optical detector is placed at the focal plane of the lens and is scanned along the fiber. Forward and backward angles ranging from 0 to 30 degrees relative to the propagation direction of the light in the fiber are focused onto different locations on the focal plane. The detector directly reads and stores the scattered intensity as a function of distance from the center of the lens.

Next, the data from the first and second setups are plotted as scattering intensity (a.u.) as a function of scattering angle (degrees) at 1550 nm. In this example, for the fibers disclosed herein, the plotted data from the first and second setups overlap within the angular range of 20 degrees to 30 degrees. It is noted that the data from the two setups discussed above are very different from each other due to different scales at which the measurements were collected. Therefore, scattering within the overlap angular range of 20 degrees to 30 degrees is used to scale the two functions together to build the full scattering function over the range of 0 degrees to 180 degrees. This provides the measured scattering angle function (y/(O)), which is used below with reference to Equation (7) to determine the SAS fraction of the total scattering loss.

As is known in the art, total scattering loss of an optical fiber is a sum of the Rayleigh Scattering Loss and SAS. In the processes disclosed herein, the contribution of Rayleigh scattering to the total scattering loss is first calculated in order to then determine the contribution of SAS to the total scattering loss. The contribution of Rayleigh scattering, which is also the Rayleigh scattering component, is calculated over the angular range of 40 degrees to 140 degrees using Equation (5).

$$S ( Θ ) = K ⋆ ( 1 + {cos}^{2} ( Θ ) ) \qquad Eq . ( 5 )$$

where S is the Rayleigh scattering component (watts), Θ is the scattering angle relative to light propagation direction (which is over the angular range of 40 degrees to 140 degrees), and K is a fixed coefficient dependent on Rayleigh scattering magnitude.

It is noted that the angular range of 40 degrees to 140 degrees is used in the embodiments disclosed herein because over this angular range, SAS does not contribute to the total scattering loss. Therefore, over this angular range, the total scattering loss is equal to the Rayleigh scattering component (S). After determining the Rayleigh scattering component (S) over the range of 40 degrees to 140 degrees using Equation (5), the Rayleigh scattering component over the full range of 0 degree to 180 degrees is determined using Equation (6) below. It is noted that over this full range, both SAS and Rayleigh scattering contribute to the total scattering loss of the fiber.

$$R 0 = 2 π {\int }_{0}^{π} S ( Θ ) sin Θ d Θ \qquad Eq . ( 6 )$$

where RO is the integrated function of the Rayleigh scattering contribution to the total scattering loss at 1550 nm, S is the Rayleigh scattering component (watts) as determined above with reference to Equation (5), and O is the scattering angle relative to light propagation direction (which is over the angular range of 0 degrees to 180 degrees).

Next, the total scattering loss is calculated using Equation (7).

$$F 0 = 2 π {\int }_{0}^{π} ψ ( Θ ) sin Θ d Θ \qquad Eq . ( 7 )$$

where FO is the integrated function of the total scattering loss (i.e., the combination of Rayleigh Scattering Loss and SAS at 1550 nm) and ψ(Θ) is the measured scattering angle function as discussed above.

Therefore, the SAS fraction of the total scattering loss is determined according to Equation (8).

$$SAS = ( F 0 - R 0 ) / F 0 \qquad Eq . ( 8 )$$

A further description to calculate SAS can be found in Mazumder, P. et al. (2004) Analysis of excess scattering in optical fibers, Journal of Applied Physics, J. Appl. Phys 96, 4042, which is incorporated herein by reference. The SAS of the optical fibers of the present disclosure varies from about 0.009 dB/km to about 0.0025 dB/km at 1550 nm.

The intrinsic absorption of the glass material is determined according to Equation (9).

$$Intrinsic Absorption = 1.17 ⋆ {10}^{12} ⋆ exp ( - 50 \; 000 / λ ) \qquad Eq . ( 9 )$$

where λ is the wavelength (nm). For alkali doped silica fiber, the intrinsic absorption is 0.015 dB/km at 1550 nm.

It is noted that for purpose of the present disclosure, B term contribution to the overall attenuation has contribution from Intrinsic Absorption, Extrinsic Absorption (defects), and Extrinsic Absorption (impurities) as illustrated in Equation (1) above. B term contribution to the total attenuation is determined by subtracting the estimated Rayleigh scattering loss and SAS loss from the total attenuation. Extrinsic Absorption (defects) is the part of B term that can be impacted by tailoring the temperature-time history fiber experiences in the slow cooling device. Thus, the change in extrinsic absorption due to glass defects is reflected in changes in B term as other contributions to B term are rather insensitive to the thermal profile in the slow cooling device.

Accordingly, the non-isothermal configuration of the slow cooling device 120 described herein may achieve a total attenuation reduction by balancing defect healing to reduce B term contribution and glass relaxation to minimize Rayleigh scattering contribution. In addition to the first average ambient temperature T₁ and the second average ambient temperature T₂ discussed above, the first residence time t₁ of the optical fiber 115 in the first zone 130 and the second residence time t₂ of the optical fiber 115 in the second zone 140 may also be configured to facilitate the total attenuation reduction. The first residence time t₁ and the second residence time t₂ may be influenced by the length of the first zone 130 and the second zone 140, respectively, and may also be influenced by the draw speed. Although FIG. 1 shows the first zone 130 and the second zone 140 have similar lengths, the first zone 130 and/or the second zone 140 may be configured with any suitable zone lengths to achieve desired first residence time t₁ and/or second residence time t₂ and/or to achieve desired first residence time t₁ to second residence time t₂ ratios.

In some embodiments, as the optical fiber 115 may be conveyed through the first zone 130 having the greater first average ambient temperature T₁, the first residence time t₁ of the optical fiber 115 in the first zone 130 may be greater than or equal to 0.03 sec, greater than or equal to 0.05 sec, greater than or equal to 0.07 sec, greater than or equal to 0.1 sec, greater than or equal to 0.2 sec, greater than or equal to 0.3 sec, or greater than or equal to 0.4 sec. In some embodiments, the first residence time t₁ of the optical fiber 115 in the first zone 130 may be less than or equal to 1 sec, less than or equal to 0.9 sec, less than or equal to 0.8 sec, less than or equal to 0.7 sec, less than or equal to 0.6 sec, less than or equal to 0.5 sec, less than or equal to 0.4 sec, less than or equal to 0.3 sec, less than or equal to 0.2 sec, or less than or equal to 0.1 sec. In some embodiments, the first residence time t₁ of the optical fiber 115 in the first zone 130 may be greater than or equal to 0.03 sec and less than or equal to 1 sec—including all sub-ranges or values therebetween. For example, in some embodiments, the first residence time t₁ of the optical fiber 115 in the first zone 130 may be greater than or equal to 0.05 sec and less than or equal to 1 sec, greater than or equal to 0.1 sec and less than or equal to 1 sec, greater than or equal to 0.2 sec and less than or equal to 1 sec, greater than or equal to 0.3 sec and less than or equal to 1 sec, greater than or equal to 0.03 sec and less than or equal to 0.9 sec, greater than or equal to 0.05 sec and less than or equal to 0.9 sec, greater than or equal to 0.1 sec and less than or equal to 0.9 sec, greater than or equal to 0.2 sec and less than or equal to 0.9 sec, greater than or equal to 0.3 sec and less than or equal to 0.9 sec, greater than or equal to 0.03 sec and less than or equal to 0.8 sec, greater than or equal to 0.05 sec and less than or equal to 0.8 sec, greater than or equal to 0.1 sec and less than or equal to 0.8 sec, greater than or equal to 0.2 sec and less than or equal to 0.8 sec, or greater than or equal to 0.3 sec and less than or equal to 0.8 sec.

In some embodiments, as the optical fiber 115 is conveyed through the second zone 140 having the lower second average ambient temperature T₂, the second residence time t₂ of the optical fiber 115 in the second zone 140 may be greater than or equal to 0.03 sec, greater than or equal to 0.05 sec, greater than or equal to 0.07 sec, greater than or equal to 0.1 sec, greater than or equal to 0.2 sec, greater than or equal to 0.3 sec, greater than or equal to 0.4 sec, greater than or equal to 0.5 sec, greater than or equal to 0.6 sec, greater than or equal to 0.7 sec, greater than or equal to 0.8 sec, greater than or equal to 0.9 sec, or greater than or equal to 1 sec. In some embodiments, the second residence time t₂ of the optical fiber 115 in the second zone 140 may be less than or equal to 2 sec, less than or equal to 1.5 sec, less than or equal to 1 sec, less than or equal to 0.9 sec, less than or equal to 0.8 sec, or less than or equal to 0.7 sec, less than or equal to 0.6 sec, less than or equal to 0.5 sec, less than or equal to 0.4 sec, less than or equal to 0.3 sec, less than or equal to 0.2 sec, or less than or equal to 0.1 sec. In some embodiments, the second residence time t₂ of the optical fiber 115 in the second zone 140 may be greater than or equal to 0.03 sec and less than or equal to 2 sec—including all sub-ranges or values therebetween. For example, in some embodiments, the second residence time t₂ of the optical fiber 115 in the second zone 140 may be greater than or equal to 0.05 sec and less than or equal to 2 sec, greater than or equal to 0.1 sec and less than or equal to 2 sec, greater than or equal to 0.2 sec and less than or equal to 2 sec, greater than or equal to 0.4 sec and less than or equal to 2 sec, greater than or equal to 0.5 sec and less than or equal to 2 sec, greater than or equal to 0.03 sec and less than or equal to 1 sec, greater than or equal to 0.05 sec and less than or equal to 1 sec, greater than or equal to 0.1 sec and less than or equal to 1 sec, greater than or equal to 0.2 sec and less than or equal to 1 sec, greater than or equal to 0.4 sec and less than or equal to 1 sec, greater than or equal to 0.5 sec and less than or equal to 1 sec, greater than or equal to 0.03 sec and less than or equal to 0.8 sec, greater than or equal to 0.05 sec and less than or equal to 0.8 sec, greater than or equal to 0.1 sec and less than or equal to 0.8 sec, greater than or equal to 0.2 sec and less than or equal to 0.8 sec, greater than or equal to 0.4 sec and less than or equal to 0.8 sec, greater than or equal to 0.5 sec and less than or equal to 0.8 sec, greater than or equal to 0.03 sec and less than or equal to 0.7 sec, greater than or equal to 0.05 sec and less than or equal to 0.7 sec, greater than or equal to 0.1 sec and less than or equal to 0.7 sec, greater than or equal to 0.2 sec and less than or equal to 0.7 sec, greater than or equal to 0.4 sec and less than or equal to 0.7 sec, or greater than or equal to 0.5 sec and less than or equal to 0.7 sec.

As discussed above, the first residence time t₁ of the optical fiber 115 in the first zone 130 and the second residence time t₂ of the optical fiber 115 in the second zone 140 may be configured such that defect healing for reducing B term contribution to total attenuation and glass relaxation for minimizing Rayleigh scattering contribution to total attenuation may be balanced for overall attenuation reduction. The inventors have recognized that the first residence time t₁ of the optical fiber 115 in the first zone 130 may be configured such that defect healing for minimizing B term contribution to attenuation may be promoted without significantly increasing Rayleigh scattering. The inventors further recognize that the second residence time t₂ of the optical fiber 115 in the second zone 140 may be configured such that sufficient glass relaxation may still be achieved to minimize Rayleigh scattering contribution to attenuation. The first residence time t₁ and the second residence time t₂ combined may be less than or equal to 3 sec, less than or equal to 2.5 sec, less than or equal to 2 sec, less than or equal to 1.5 sec, less than or equal to 1 sec, less than or equal to 0.75 sec, less than or equal to 0.5 sec, less than or equal to 0.4 sec, or less than or equal to 0.3 sec. Thus, the non-isothermal configuration of the slow cooling device 120 described herein may allow for further reduction in attenuation while maintaining production efficiency.

In some embodiments, a ratio of the first residence time tᵢ of the optical fiber 115 in the first zone 130 to the second residence time t₂ of the optical fiber 115 in the second zone 140 may be greater than or equal to 0.14:1 such that the first residence time tᵢ of the optical fiber 115 in the first zone 130 may allow for sufficient reduction in B term contribution to the attenuation of the optical fiber 115. In some embodiments, the ratio of the first residence time tᵢ to the second residence time t₂ may be greater than or equal to 0.15:1, greater than or equal to 0.2:1, greater than or equal to 0.3:1, greater than or equal to 0.4:1, greater than or equal to 0.5:1, greater than or equal to 0.75:1, greater than or equal to 1:1, greater than or equal to 2:1, greater than or equal to 3:1, greater than or equal to 4:1, or greater than or equal to 5:1.

In some embodiments, the ratio of the first residence time t₁ of the optical fiber 115 in the first zone 130 to the second residence time t₂ of the optical fiber 115 in the second zone 140 may be less than or equal to 5.3:1 such that the second residence time t₂ of the optical fiber 115 in the second zone 140 may allow for sufficient reduction in the Rayleigh scattering contribution to the attenuation of the optical fiber 115. In some embodiments, the ratio of the first residence time t₁ to the second residence time t₂ may be less than or equal to 5:1, less than or equal to 4.5:1, less than or equal to 3.5:1, less than or equal to 2.5:1, less than or equal to 1.5:1, less than or equal to 1:1, less than or equal to 0.8:1, less than or equal to 0.6:1, less than or equal to 0.4:1, or less than or equal to 0.2:1.

In some embodiments, the ratio of the first residence time t₁ of the optical fiber 115 in the first zone 130 to the second residence time t₂ of the optical fiber 115 in the second zone 140 may be greater than or equal to 0.14:1 and less than or equal to 5.3:1—including all sub-ranges or values therebetween. For example, in some embodiments, the ratio of the first residence time t₁ to the second residence time t₂ may be greater than or equal to 0.16:1 and less than or equal to 5.1:1, greater than or equal to 0.17:1 and less than or equal to 2.7:1, or greater than or equal to 0.19:1 or less than or equal to 2.1:1. In some embodiments, the ratio of the first residence time t₁ to the second residence time t₂ may be greater than or equal to 0.25:1 and less than or equal to 3.6:1, greater than or equal to 0.3:1 and less than or equal to 2.8:1, or greater than or equal to 0.42:1 or less than or equal to 2.2:1. In some embodiments, the ratio of the first residence time t₁ to the second residence time t₂ may be greater than or equal to 0.16:1 and less than or equal to 0.68:1, greater than or equal to 0.19:1 and less than or equal to 0.65:1, or greater than or equal to 0.19:1 or less than or equal to 0.57:1. In some embodiments, the ratio of the first residence time t₁ to the second residence time t₂ may be greater than or equal to 0.2:1 and less than or equal to 2:1, greater than or equal to 0.3:1 and less than or equal to 1.5:1, greater than or equal to 0.4:1 and less than or equal to 1:1, or greater than or equal to 0.5:1 and less than or equal to 0.75:1. In some embodiments, the ratio of the first residence time t₁ to the second residence time t₂ may be greater than or equal to 0.14:1 and less than or equal to 0.5:1, greater than or equal to 0.16:1 and less than or equal to 0.4:1, greater than or equal to 0.18:1 and less than or equal to 0.3:1, or greater than or equal to 0.2:1 and less than or equal to 0.25:1. In some embodiments, the ratio of the first residence time t₁ to the second residence time t₂ may be greater than or equal to 0.5:1 and less than or equal to 5.3:1, greater than or equal to 1:1 and less than or equal to 4:1, greater than or equal to 1.5:1 and less than or equal to 3:1, or greater than or equal to 1.75:1 and less than or equal to 2.5:1.

In some embodiments, the first residence time t₁ may be less than or equal to the second residence time t₂. For example, in some embodiments, the second residence time t₂ may be greater than the first residence time t₁, and a ratio of the second residence time t₂ to the first residence time t₁ may be greater than or equal to 1.5:1, greater than or equal to 1.7:1, greater than or equal to 1.9:1, greater than or equal to 2:1, greater than or equal to 2.5:1, greater than or equal to 3:1, greater than or equal to 3.5:1, greater than or equal to 4:1, or greater than or equal to 4.5:1.

Utilizing the non-isothermal slow cooling device described herein, specifically with the first average ambient temperature T₁, the first residence time t₁, the second average ambient temperature T₂, and/or the second residence time t₂ described herein, a total attenuation of the optical fiber described herein, e.g., alkali doped optical fiber, may be less than or equal to 0.16 dB/km at 1550 nm, less than or equal to 0.155 dB/km at 1550 nm, less than or equal to 0.150 dB/km at 1550 nm, or less than or equal to 0.145 dB/km at 1550. The B term contribution to the total attenuation of the optical fiber may be greater than or equal to 0.0005 dB/km and less than or equal to 0.0025 dB/km at 1550 nm—including all sub-ranges or values therebetween. For example, in embodiments, the B term contribution to the total attenuation of the optical fiber may be greater than or equal to 0.0005 dB/km and less than or equal to 0.0025 dB/km at 1550 nm, greater than or equal to 0.0005 dB/km and less than or equal to 0.002 dB/km at 1550 nm, greater than or equal to 0.0005 dB/km and less than or equal to 0.0015 dB/km at 1550 nm, greater than or equal to 0.0005 dB/km and less than or equal to 0.001 dB/km at 1550 nm, greater than or equal to 0.001 dB/km and less than or equal to 0.0025 dB/km at 1550 nm, greater than or equal to 0.001 dB/km and less than or equal to 0.002 dB/km at 1550 nm, greater than or equal to 0.001 dB/km and less than or equal to 0.0015 dB/km at 1550 nm, greater than or equal to 0.0015 dB/km and less than or equal to 0.0025 dB/km at 1550 nm, greater than or equal to 0.0015 dB/km and less than or equal to 0.002 dB/km at 1550 nm, or greater than or equal to 0.002 dB/km and less than or equal to 0.0025 dB/km at 1550 nm. In embodiments, the B term contribution to the total attenuation of the optical fiber may be less than or equal to 0.0025 dB/km at 1550 nm, less than or equal to 0.002 dB/km at 1550 nm, less than or equal to 0.0015 dB/km at 1550 nm, less than or equal to 0.001 dB/km at 1550 nm, or less.

In some embodiments, the Rayleigh scattering coefficient of the optical fiber described herein, such as the weighted average Rayleigh scattering coefficient of the optical fiber at 1550 nm as described above, may be less than or equal to 0.75 dB/km*micron⁴, less than or equal to 0.74 dB/km*micron⁴, or less than or equal to 0.72 dB/km*micron⁴. In some embodiments, the Rayleigh scattering coefficient of the optical fiber drawn may be greater than or equal to 0.64 dB/km*micron⁴. In some embodiments, the Rayleigh scattering coefficient of the optical fiber drawn may be greater than or equal to 0.64 dB/km*micron⁴ and less than or equal to 0.75 dB/km*micron⁴, greater than or equal to 0.64 dB/km*micron⁴ and less than or equal to 0.74 dB/km*micron⁴, or greater than or equal to 0.64 dB/km*micron⁴ and less than or equal to 0.72 dB/km*micron⁴.

In some embodiments, the optical fiber described herein may have an effective area greater than 75 m² at 1550 nm, greater than 100 m² at 1550 nm, or greater than 120 m² at 1550 nm.

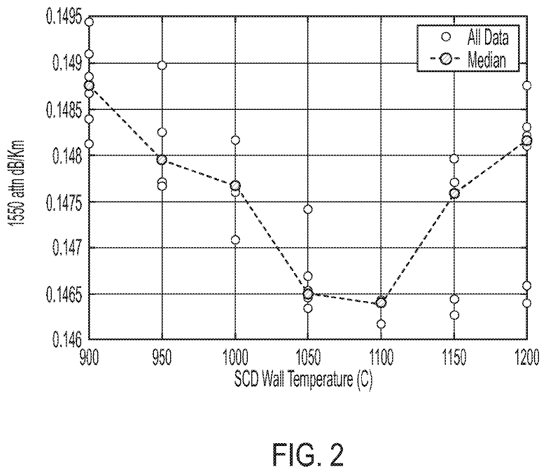

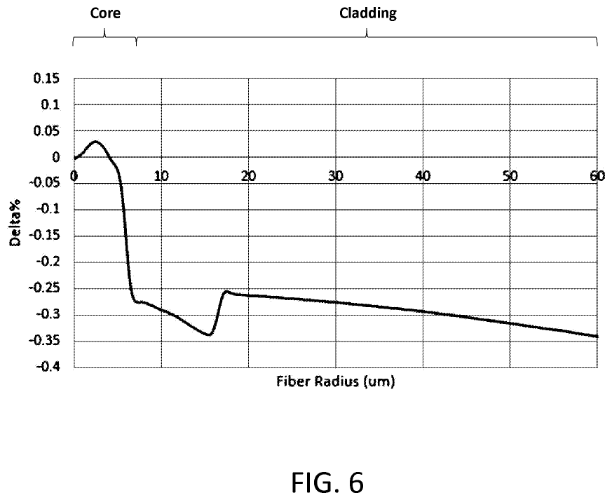

FIG. 2 shows total attenuation for alkali doped optical fibers at 1550 nm as a function of the ambient temperature (same as wall temperature) of an isothermal slow cooling device configured to provide a constant ambient temperature. Specifically, for each data point collected, the slow cooling device is configured to operate at a constant temperature and provide a residence time of the alkali doped optical fiber in the slow cooling device of 0.3 seconds at that constant temperature. The various fibers shown in FIG. 2 were drawn from the same preform. The fibers were drawn at a draw speed of 20 m/s. The temperature of the fiber entering the isothermal slow cooling device was 1200° C. FIG. 6 plots the relative refractive index profile of the fiber drawn showing the relationship between the relative refractive index and the radius of the fiber. The average alkali concentration in the core region is about 70 ppm, and the fluorine concentration in the cladding region ranges from about 0.8 wt % to 1.2 wt %. An effective area of the fiber is about 112 μm² at 1550 nm. A mode field diameter of the fiber is about 12 μm at 1550 nm.

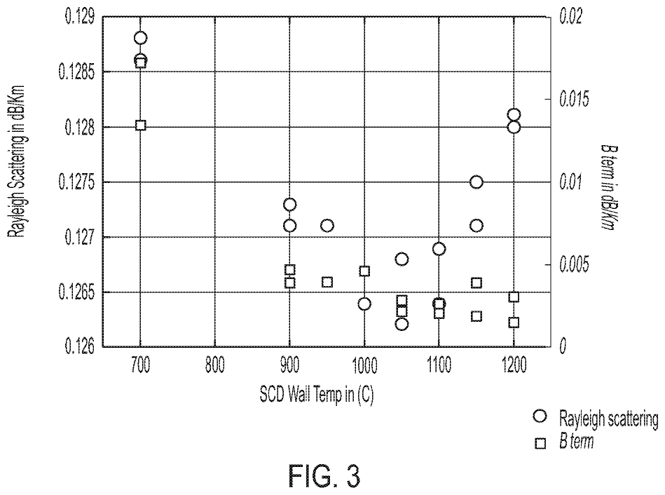

The respective contributions of Rayleigh scattering and B term (absorption from glass defects) to the total attenuation as a function of the ambient temperature (same as wall temperature) of the isothermal slow cooling device are shown in FIG. 3. The Rayleigh scattering and B term contributions to the total attenuation are obtained based on Equations [1]-[8] and related description described above.

It is discovered that minimum Rayleigh scattering is achieved at an intermediate slow cooling device temperature while surprisingly, minimum B term is observed at the highest slow cooling device temperature. Without intending to be bound to any particular theory, the kinetics of defect annealing may increase with temperature, resulting in fewer defects and lower B term contributions to total attenuation at the highest slow cooling device temperature, e.g., 1200° C. On the other hand, the Rayleigh scattering coefficient is linearly proportional to the glass fictive temperature and the kinetics of the relaxation can be described by the following relation:

$$\frac{{dT}_{f}}{dt} = - \frac{( T - {T}_{f} )}{τ} \qquad Eq . ( 10 )$$

where T is the fiber temperature, T_{f} is the glass fictive temperature, and i is the characteristics time for relaxation. The characteristic time of relaxation i can be estimated as:

$$τ = \frac{K μ ( T , {T}_{f} )}{G} \qquad Eq . ( 11 )$$

where K is a constant and has a value ranging between 10 and 500, p is the viscosity, and G is the shear modulus. Without intending to be bound to any particular theory, the minimum Rayleigh scattering observed at the intermediate slow cooling device temperature, e.g., 1050° C., may be on account of optimization between the driving force (numerator in Equation (10)) and lower rate of relaxation at lower temperature (mainly due to viscosity in the denominator of Equation (10)).

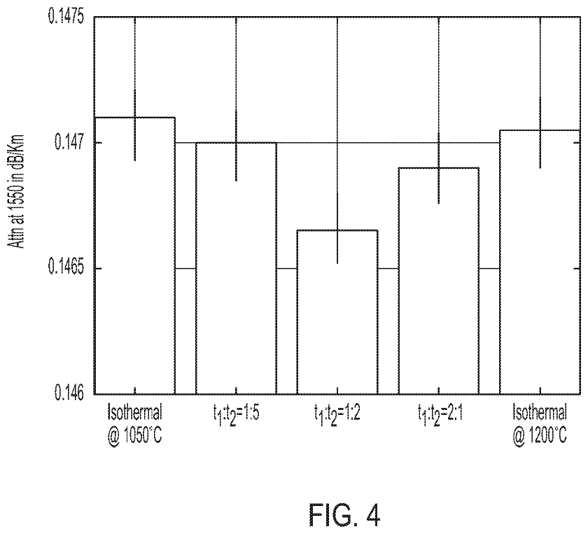

FIG. 4 shows total attenuation at 1550 nm of alkali doped optical fibers drawn at different slow cooling conditions, with some at isothermal conditions and others at non-isothermal conditions. Specifically, some of the alkali doped optical fibers were conveyed through a slow cooling device configured to provide an isothermal ambient temperature of 1050° C. and 1200° C., respectively. Some of the alkali doped optical fibers were each conveyed through a non-isothermal slow cooling device having a first (or upstream) zone of 1200° C. and a second (or downstream) zone of 1050° C., with the first and second zones being adjacent to each other (i.e., no other intervening zones) and a ratio of the first residence time t₁ in the first zone to the second residence time t₂ in the second zone being 1:5, 1:2, and 2:1, respectively. The total residence time of each alkali doped optical fiber in the slow cooling device (isothermal or non-isothermal) was the same.

The various fibers shown in FIG. 4 were drawn from the same preform as that used for drawing the fibers shown in FIG. 2, and the fibers drawn also has the relative refractive index profile shown in FIG. 6. The fibers were drawn at the same draw speed of 20 m/s, and the temperature of the fiber entering the isothermal slow cooling device was 1200° C. The average alkali concentration in the core region is about 70 ppm, and the fluorine concentration in the cladding region ranges from about 0.8 wt % to 1.2 wt %. An effective area of the fiber is about 112 m² at 1550 nm. A mode field diameter of the fiber is about 12 m at 1550 nm.

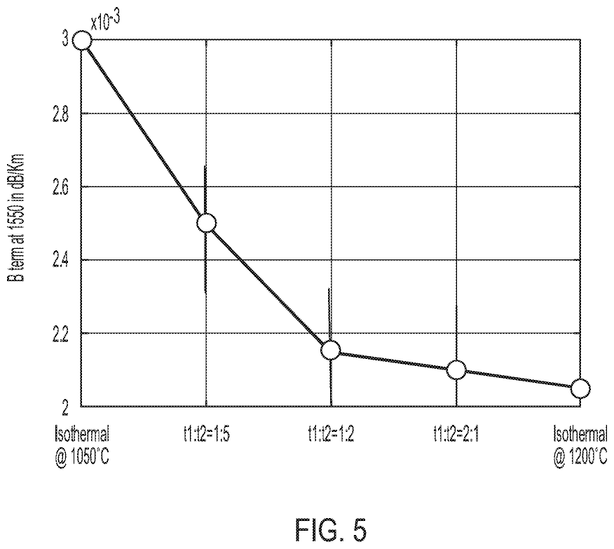

FIG. 5 shows B term contribution to the total attenuation of the alkali doped optical fibers of FIG. 4. It is discovered that as the second residence time t₂ in the second zone at 1200° C. increases, B term contribution due to defects in the glass composition reduces from about 0.003 dB/km to about 0.002 dB/km, with more significant reduction observed when the slow cooling condition changes from isothermal ambient temperature of 1050° C. to non-isothermal conditions where the ratio of the first residence time t₁ at 1200° C. to the second residence time t₂ at 1050° C. increases to 1:2. Further increase in the first residence time tᵢ to second residence time t₂ ratio beyond 1:2, such 2:1 or isothermal ambient temperature of 1200° C., reduction in B term contribution appears to saturate.

Although Rayleigh scattering contribution to the total attenuation may increase when the ambient temperature increases from 1050° C. to 1200° C., as predicted by modeling (increase of 0.0005 dB/Km) and as shown in FIG. 3, a net reduction in total attenuation can nonetheless be achieved with appropriate non-isothermal slow cooling conditions. In fact, as shown in FIG. 4, all non-isothermal slow cooling conditions yielded surprisingly lower total attenuation when compared to isothermal slow cooling conditions at either 1200° C. or 1050° C. Accordingly, the non-isothermal slow cooling device described herein can achieve surprisingly low total attenuation. The non-isothermal slow cooling device described herein may include at least one upstream zone configured to operate at a higher ambient temperature for promoting defect healing to reduce B term contribution and at least one downstream zone configured to operate at a lower ambient temperature for facilitating glass relaxation to minimize Rayleigh scattering contribution, thereby achieving overall low attenuation.

While the techniques and/or procedures are depicted and/or described in a certain order for purpose of illustration, it should be appreciated that certain techniques and/or procedures may be re-ordered and/or omitted within the scope of various embodiments.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

### Exemplary Claim Set

Exemplary Claim 1. A method of drawing an optical fiber, comprising: directing an optical fiber comprising an alkali dopant through an inlet of a slow cooling device to a first zone within the slow cooling device, wherein the first zone has a first average ambient temperature T₁; cooling the optical fiber from a first fiber temperature to a second fiber temperature at a first cooling rate in the first zone, wherein: the first cooling rate is less than 5000° C./s, and a first residence time t₁ of the optical fiber in the first zone is greater than or equal to 0.03 sec; directing the optical fiber from the first zone to a second zone within the slow cooling device, wherein: the second zone has a second average ambient temperature T₂ of at least 900° C., and the first average ambient temperature T₁ is greater than the second average ambient temperature T₂ by at least 100° C.; cooling the optical fiber from a third fiber temperature to a fourth fiber temperature at a second cooling rate in the second zone, wherein: the third fiber temperature is less than or equal to the second fiber temperature, the second cooling rate is greater than the first cooling rate and less than 5000° C./s, and a second residence time t₂ in the second zone is greater than the first residence time t₁, wherein a ratio of the second residence time t₂ to the first residence time t₁ is greater than or equal to 1.5:1; wherein a Rayleigh scattering coefficient of the optical fiber drawn by the method is less than 0.75 dB/km*micron⁴; and wherein an attenuation of the optical fiber drawn by the method is less than 0.16 dB/km at 1550 nm.

Exemplary Claim 2. A method of drawing an optical fiber, comprising: directing an optical fiber comprising an alkali dopant through an inlet of a slow cooling device to a first zone within the slow cooling device, wherein: the first zone has a first average ambient temperature T₁; cooling the optical fiber from a first fiber temperature to a second fiber temperature at a first cooling rate in the first zone, wherein: the first cooling rate is less than 5000° C./s; directing the optical fiber from the first zone to a second zone within the slow cooling device, wherein: the second zone has a second average ambient temperature T₂ of at least 900° C., and the first average ambient temperature T₁ is greater than the second average ambient temperature T₂ by at least 100° C.; cooling the optical fiber from a third fiber temperature to a fourth fiber temperature at a second cooling rate in the second zone, wherein: the third fiber temperature is less than or equal to the second fiber temperature, the second cooling rate is greater than the first cooling rate and less than 5000° C./s, and a ratio of a first residence time t₁ of the optical fiber in the first zone to a second residence time t₂ in the second zone is greater than or equal to 0.14:1 and less than or equal to 5.3:1; wherein a Rayleigh scattering coefficient of the optical fiber drawn by the method is less than 0.75 dB/km*micron⁴; and wherein an attenuation of the optical fiber drawn by the method is less than 0.16 dB/km at 1550 nm.

Exemplary Claim 3. The method of Exemplary Claim 2, wherein the ratio of the first residence time t1 to the second residence time t₂ is greater than or equal to 0.14:1 and less than or equal to 5.3:1 such that the first residence time t₁ of the optical fiber in the first zone sufficiently reduce a B term contribution to attenuation of the optical fiber while the second residence time t₂ of the optical fiber in the second zone sufficiently reduce a Rayleigh scattering contribution to the attenuation of the optical fiber.

Exemplary Claim 4. The method of any of Exemplary Claim 2 to Exemplary Claim 3, wherein the ratio of the first residence time t₁ to the second residence time t₂ is greater than or equal to 0.16:1 and less than or equal to 5.1:1, preferably greater than or equal to 0.17:1 and less than or equal to 2.7:1, or more preferably greater than or equal to 0.19:1 or less than or equal to 2.1:1.

Exemplary Claim 5. The method of any of Exemplary Claim 2 to Exemplary Claim 4, wherein the ratio of the first residence time t₁ to the second residence time t₂ is greater than or equal to 0.25:1 and less than or equal to 3.6:1, preferably greater than or equal to 0.3:1 and less than or equal to 2.8:1, or more preferably greater than or equal to 0.42:1 or less than or equal to 2.2:1.

Exemplary Claim 6. The method of any of Exemplary Claim 2 to Exemplary Claim 5, wherein the first residence time t₁ is less than or equal to the second residence time t₂.

Exemplary Claim 7. The method of any of Exemplary Claim 2 to Exemplary Claim 6, wherein the ratio of the first residence time t₁ to the second residence time t₂ is greater than or equal to 0.16:1 and less than or equal to 0.68:1, preferably greater than or equal to 0.19:1 and less than or equal to 0.65:1, or more preferably greater than or equal to 0.19:1 or less than or equal to 0.57:1.

Exemplary Claim 8. A method of drawing an optical fiber, comprising: directing an optical fiber comprising an alkali dopant through an inlet of a slow cooling device to a first zone within the slow cooling device; cooling the optical fiber from a first fiber temperature to a second fiber temperature at a first cooling rate in the first zone; wherein: the first zone has a first average ambient temperature T₁ that is greater than or equal to 1070° C. and less than or equal to 1320° C., and a first residence time t₁ of the optical fiber in the first zone is greater than or equal to 0.03 sec and less than or equal to 1 sec; directing the optical fiber from the first zone to a second zone within the slow cooling device; and cooling the optical fiber from a third fiber temperature to a fourth fiber temperature at a second cooling rate in the second zone; wherein: the third fiber temperature is less than or equal to the second fiber temperature, the second cooling rate is greater than the first cooling rate and less than 5000° C./s, the second zone has a second average ambient temperature T₂ that is greater than or equal to 900° C. and less than or equal to 1200° C., and a second residence time t₂ in the second zone is greater than or equal to 0.03 sec and less than or equal to 2 sec; wherein a Rayleigh scattering coefficient of the optical fiber drawn by the method is less than 0.75 dB/km*micron⁴; and wherein an attenuation of the optical fiber drawn by the method is less than 0.16 dB/km at 1550 nm.

Exemplary Claim 9. The method of any of Exemplary Claim 1 to Exemplary Claim 8, wherein the first residence time t₁ of the optical fiber in the first zone is greater than or equal to 0.1 sec, greater than or equal to 0.2 sec, or greater than or equal to 0.3 sec.

Exemplary Claim 10. The method of any of Exemplary Claim 1 to Exemplary Claim 9, wherein the first residence time t₁ of the optical fiber in the first zone is greater than or equal to 0.1 sec and less than or equal to 1 sec, greater than or equal to 0.2 sec and less than or equal to 1 sec, greater than or equal to 0.3 sec and less than or equal to 0.8 sec.

Exemplary Claim 11. The method of any of Exemplary Claim 1 to Exemplary Claim 10, wherein the second residence time t₂ of the optical fiber in the second zone is greater than or equal to 0.2 sec, greater than or equal to 0.4 sec, or greater than or equal to 0.5 sec.

Exemplary Claim 12. The method of any of Exemplary Claim 1 to Exemplary Claim 11, wherein the second residence time t₂ of the optical fiber in the second zone is greater than or equal to 0.2 sec and less than or equal to 1 sec, greater than or equal to 0.4 sec and less than or equal to 0.8 sec, or greater than or equal to 0.5 sec and less than or equal to 0.7 sec.

Exemplary Claim 13. The method of any of Exemplary Claim 1 to Exemplary Claim 12, wherein a difference between the first average ambient temperature T₁ and the second average ambient temperature T₂ is greater than or equal to 100° C. and less than or equal to 200° C., greater than or equal 112° C. and less than or equal to 176° C., greater than or equal to 129° C. and less than or equal to 158° C., or greater than or equal to 142° C. and less than or equal to 155° C.

Exemplary Claim 14. The method of any of Exemplary Claim 1 to Exemplary Claim 13, wherein: the optical fiber comprises a core region and a cladding region; and an average concentration of the alkali dopant in the core region is greater than or equal to 20 ppm and less than or equal to 500 ppm.

Exemplary Claim 15. The method of any of Exemplary Claim 1 to Exemplary Claim 14, wherein the first average ambient temperature Tᵢ of the first zone is greater than equal to 1150° C., greater than equal to 1200° C., or greater than equal to 1250° C.

Exemplary Claim 16. The method of any of Exemplary Claim 1 to Exemplary Claim 15, wherein the first average ambient temperature T₁ of the first zone is greater than equal to 1150° C. and less than or equal to 1250° C., greater than equal to 1200° C. and less than or equal to 1275° C., or greater than equal to 1250° C. and less than or equal to 1300° C.

Exemplary Claim 17. The method of any of Exemplary Claim 1 to Exemplary Claim 16, wherein the second average ambient temperature T₂ of the second zone is less than equal to 1150° C., less than or equal to 1100° C., or less than or equal to 1050° C.

Exemplary Claim 18. The method of any of Exemplary Claim 1 to Exemplary Claim 17, wherein the second average ambient temperature T₂ of the second zone is greater than or equal to 900° C. and less than equal to 1150° C., greater than or equal to 950° C. and less than or equal to 1100° C., or greater than or equal to 975° C. and less than or equal to 1050° C.

Exemplary Claim 19. The method of any of Exemplary Claim 1 to Exemplary Claim 18, wherein the attenuation of the optical fiber is less than or equal to 0.155 dB/km at 1550 nm, less than or equal to 0.150 dB/km at 1550 nm, or less than or equal to 0.145 dB/km at 1550.

Exemplary Claim 20. The method of any of Exemplary Claim 1 to Exemplary Claim 19, wherein the Rayleigh scattering coefficient of the optical fiber drawn by the method is less than 0.74 dB/km*micron⁴, or less than 0.72 dB/km*micron⁴.

Exemplary Claim 21. The method of any of Exemplary Claim 1 to Exemplary Claim 20, wherein the optical fiber has an effective area of greater than 75 m² at 1550 nm, greater than 100 m² at 1550 nm, or greater than 120 m² at 1550 nm.

Exemplary Claim 22. The method of any of Exemplary Claim 1 to Exemplary Claim 21, further comprising: drawing the optical fiber from a preform situated in a draw furnace, wherein the slow cooling device is positioned downstream of the draw furnace.

Exemplary Claim 23. The method of any of Exemplary Claim 1 to Exemplary Claim 22, wherein a B term contribution to the attenuation of the optical fiber ranges from 0.0005 dB/km to 0.0025 dB/km at 1550 nm.

What is claimed is:

1. A method of drawing an optical fiber, comprising:
directing an optical fiber comprising an alkali dopant through an inlet of a slow cooling device to a first zone within the slow cooling device, wherein:
the first zone has a first average ambient temperature T₁;
cooling the optical fiber from a first fiber temperature to a second fiber temperature at a first cooling rate in the first zone, wherein:
the first cooling rate is less than 5000° C./s; and
a first residence time t₁ of the optical fiber in the first zone is greater than or equal to 0.03 sec;
directing the optical fiber from the first zone to a second zone within the slow cooling device, wherein:
the second zone has a second average ambient temperature T₂ of at least 900° C.; and
the first average ambient temperature T₁ is greater than the second average ambient temperature T₂ by at least 100° C.;
cooling the optical fiber from a third fiber temperature to a fourth fiber temperature at a second cooling rate in the second zone, wherein:
the third fiber temperature is less than or equal to the second fiber temperature;
the second cooling rate is greater than the first cooling rate and less than 5000° C./s; and
a second residence time t₂ in the second zone is greater than the first residence time t₁, wherein a ratio of the second residence time t₂ to the first residence time t₁ is greater than or equal to 1.5:1;
wherein a Rayleigh scattering coefficient of the optical fiber drawn by the method is less than 0.75 dB/km*micron⁴; and
wherein an attenuation of the optical fiber drawn by the method is less than 0.16 dB/km at 1550 nm.

2. The method of claim 1, wherein the first residence time t₁ of the optical fiber in the first zone is greater than or equal to 0.1 sec.

3. The method of claim 1, wherein the first residence time t₁ of the optical fiber in the first zone is less than or equal to 1 sec.

4. The method of claim 1, wherein the second residence time t₂ of the optical fiber in the second zone is greater than or equal to 0.2 sec.

5. The method of claim 1, wherein the second residence time t₂ of the optical fiber in the second zone is less than or equal to 1 sec.

6. The method of claim 1, wherein:
the optical fiber comprises a core region and a cladding region; and
an average concentration of the alkali dopant in the core region is greater than or equal to 20 ppm and less than or equal to 500 ppm.

7. The method of claim 1, wherein the first average ambient temperature T₁ of the first zone is greater than equal to 1150° C.

8. The method of claim 1, wherein the first average ambient temperature T₁ of the first zone is less than or equal to 1250° C.

9. The method of claim 1, wherein the second average ambient temperature T₂ of the second zone is less than equal to 1150° C.

10. The method of claim 1, wherein the attenuation of the optical fiber is less than or equal to 0.155 dB/km at 1550 nm, and wherein the optical fiber has an effective area of greater than 75 m² at 1550 nm.

11. The method of claim 1, wherein a B term contribution to the attenuation of the optical fiber ranges from 0.0005 dB/km to 0.0025 dB/km at 1550 nm.

12. A method of drawing an optical fiber, comprising:
directing an optical fiber comprising an alkali dopant through an inlet of a slow cooling device to a first zone within the slow cooling device, wherein:
the first zone has a first average ambient temperature T₁;
cooling the optical fiber from a first fiber temperature to a second fiber temperature at a first cooling rate in the first zone, wherein:
the first cooling rate is less than 5000° C./s;
directing the optical fiber from the first zone to a second zone within the slow cooling device, wherein:
the second zone has a second average ambient temperature T₂ of at least 900° C.; and
the first average ambient temperature T₁ is greater than the second average ambient temperature T₂ by at least 100° C.;
cooling the optical fiber from a third fiber temperature to a fourth fiber temperature at a second cooling rate in the second zone, wherein:
the third fiber temperature is less than or equal to the second fiber temperature;
the second cooling rate is greater than the first cooling rate and less than 5000° C./s; and
a ratio of a first residence time t₁ of the optical fiber in the first zone to a second residence time t₂ in the second zone is greater than or equal to 0.14:1 and less than or equal to 5.3:1;
wherein a Rayleigh scattering coefficient of the optical fiber drawn by the method is less than 0.75 dB/km*micron⁴; and
wherein an attenuation of the optical fiber drawn by the method is less than 0.16 dB/km at 1550 nm.

13. The method of claim 12, wherein the ratio of the first residence time t₁ to the second residence time t₂ is greater than or equal to 0.25:1 and less than or equal to 3.6:1.

14. The method of claim 12, wherein the first residence time t₁ is less than or equal to the second residence time t₂.

15. The method of claim 12, wherein the ratio of the first residence time t₁ to the second residence time t₂ is greater than or equal to 0.16:1 and less than or equal to 0.68:1.

16. The method of claim 12, wherein the first average ambient temperature T₁ of the first zone is greater than equal to 1150° C. and less than or equal to 1250° C.

17. The method of claim 12, wherein the second average ambient temperature T₂ of the second zone is less than equal to 1150° C.

18. A method of drawing an optical fiber, comprising:
directing an optical fiber comprising an alkali dopant through an inlet of a slow cooling device to a first zone within the slow cooling device;
cooling the optical fiber from a first fiber temperature to a second fiber temperature at a first cooling rate in the first zone;
wherein:
the first zone has a first average ambient temperature T₁ that is greater than or equal to 1070° C. and less than or equal to 1320° C.; and
a first residence time t₁ of the optical fiber in the first zone is greater than or equal to 0.03 sec and less than or equal to 1 sec;
directing the optical fiber from the first zone to a second zone within the slow cooling device; and
cooling the optical fiber from a third fiber temperature to a fourth fiber temperature at a second cooling rate in the second zone;
wherein:
the third fiber temperature is less than or equal to the second fiber temperature;
the second cooling rate is greater than the first cooling rate and less than 5000° C./s;
the second zone has a second average ambient temperature T₂ that is greater than or equal to 900° C. and less than or equal to 1200° C.; and
a second residence time t₂ in the second zone is greater than or equal to 0.03 sec and less than or equal to 2 sec;
wherein a Rayleigh scattering coefficient of the optical fiber drawn by the method is less than 0.75 dB/km*micron⁴; and
wherein an attenuation of the optical fiber drawn by the method is less than 0.16 dB/km at 1550 nm.

19. The method of claim 18, wherein a difference between the first average ambient temperature T₁ and the second average ambient temperature T₂ is less than or equal to 200° C.

20. The method of claim 18, wherein a ratio of the first residence time t₁ to the second residence time t₂ is greater than or equal to 0.14:1 and less than or equal to 5.3:1.
